(19) United States
(12) Patent Application Publication
(10) Pub. No.: US 2007/0006497 A1
(43) Pub. Date: Jan. 11, 2007

(54) Visibility Control Device for Vehicle Display

(76) Inventor: Jeff Alberts, Brier, WA (US)

Correspondence Address: JEFF ALBERTS, 3014 226 PL. SW, BRIER, WA, 98036, US

(21) Appl. No.: 11/160,817

(22) Filed: Jul. 11, 2005

(51) Int. Cl. G09F 21/04

(52) U.S. Cl. 40/593

(57) ABSTRACT

An apparatus for a display device comprising a display holder or aperture, an attachment assembly, and an obscuring assembly for selectively obscuring or revealing the display such that the visibility of the display can be controlled manually, remotely, or automatically by the operator.

### FIELD OF THE INVENTION

This invention relates generally to display devices for transportation vehicles and, more specifically, to a device that allows the user to determine when a display will be visible to others.

### BACKGROUND OF THE INVENTION

There are a number of known holders for replaceable, temporary or semi-permanent graphical image displays. Examples of such graphical image displays include bumper stickers, advertisements, affiliations and vanity statements. Such holders take a variety of forms. Many of the improvements that have been made in such devices are intended to improve ease of use, or to facilitate changing of the messages they are intended to display. Some improvements are intended to allow adjustments in the orientation of the message, or to provide aesthetic improvements to the display device itself. In spite of the many improvements, each has overlooked a significant deficiency inherent in the prior art.

By design, such display devices are intended to present a viewable message to others—generally to the public. This can present a personal or property threat in some situations. For example, many of the messages that are routinely displayed in the form of bumper stickers are of a political or other controversial nature. This can result in acts of road-rage or other aggressive or violent behavior by members of the public. Moreover, because these displays are often left unattended, such as in or on a parked vehicle, presentation of a controversial message can lead to acts of vandalism. Message content need not lead to violence or property damage for display to be of issue. In some cases, certain messages may result in social stigma. Display within certain areas such as the workplace parking lot or certain neighborhoods may also present a privacy issue.

In this context the deficiencies in the current art and advantages of the subject invention can be readily seen. While some prior devices provide for manual changes to the display, or removal of the entire display device, none provide a simple means to quickly and easily prevent the display image from being viewed by others. In particular, with existing devices it is difficult, unsafe or impossible for the driver to obstruct the message or manually adjust the display device in a moving vehicle. Even if the display device is within reach, manual manipulation of the message or device while underway presents a significant safety issue. While in certain circumstances existing devices might be manually covered or otherwise obstructed by the user, doing so would be cumbersome and inconvenient. Additionally, the inconvenience of manually moving, adjusting or obstructing the display device may cause the user to forget or neglect to adjust the device, or cause the user to take unnecessary personal or property risks even at times when the device is accessible. Accordingly, there exists a need for a display device having a selectively obscured image.

### BRIEF DESCRIPTION OF DRAWINGS

FIG. 1 is a frontal view of an embodiment of the display device in the obstructed configuration with the display holder obstructed by an obscuring assembly.

FIG. 2 is a frontal view of the display device with the obscuring assembly in the unobstructed configuration with the display holder visible.

FIG. 3A is a frontal view of a semi-rigid surface to which a graphical image may be affixed.

FIG. 3B is a frontal view of the semi-rigid surface shown in FIG. 3A with a notional graphical image affixed.

FIG. 4 is a frontal view of the display device as shown in FIG. 2 with the semi-rigid surface and notional graphical image of FIG. 3B inserted into the display holder.

FIG. 5 is a rear view of the display device embodiment shown in FIG. 2 with important internal or external features identified.

FIGS. 6A and 6B represent an alternative embodiment of the invention. In this embodiment an electro chromic cover forms an obscuring assembly that obstructs the view of a graphical image when energized.

FIGS. 7A, 7B and 7C represent another alternative embodiment of the invention. In this embodiment a graphical image is obstructed from view by an obscuring assembly that folds a display holder over upon itself.

FIGS. 8A, 8B and 8C represent still another alternative embodiment of the invention. In this embodiment a graphical image is obstructed from view by an obscuring assembly that rolls a flexible display holder around a pair of drums.

FIGS. 9A and 9B represent yet another alternative embodiment of the invention. In this embodiment the graphical image is obstructed from view by an obscuring assembly that rotates a display holder within the display device.

FIGS. 10A and 10B represent yet another alternative embodiment of the invention. In this embodiment the invention is configured to obstruct the view of a graphical image that is affixed to a surface such as the exterior of an automobile.

Wherever practicable, the same numeral is used to identify identical or substantially similar features appearing in the several figures. The wording of the notional graphical images in the figures as well as any other wording in any of the figures describing alternative embodiments is for illustration only and forms no part of the claimed design.

### DETAILED DESCRIPTION OF THE INVENTION

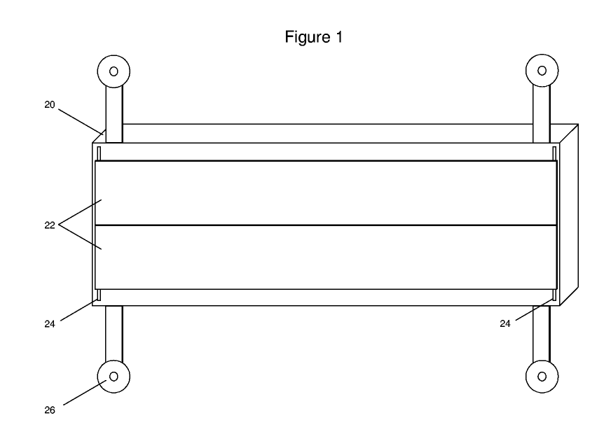

FIG. 1 depicts one embodiment of a display device 20 in a first configuration wherein a graphical image is obstructed from view. In this configuration, an obscuring assembly is formed by a pair of movable panels 22. The moveable panels 22 have been traversed inwardly along slotted tracks 24 to form a closed shutter which obstructs the view of a display holder. A plurality of mounting arms 26 form an attachment assembly that serves to affix the display device 20 to a rear vehicle window or other surface. While in this embodiment suction cups are used to affix the device, alternative attachment assemblies can be readily conceived.

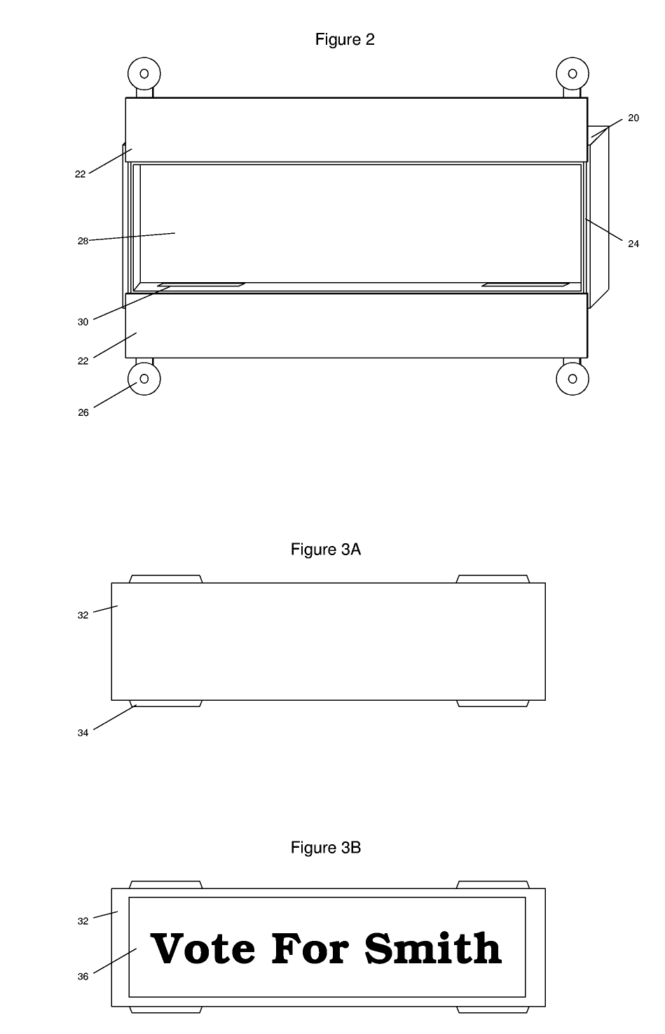

FIG. 2 illustrates the same frontal view of the display device 20 of FIG. 1 in a second unobstructed configuration wherein a display holder 28 is visible. In this configuration the movable panels 22 which form the obscuring assembly have been traversed outwardly along the tracks 24 to form an open shutter which reveals the display holder 28. The opening of the obscuring assembly shutter also reveals a lower pair of a plurality of retainer slots 30.

FIG. 3A illustrates a removable display surface 32 equipped with a plurality of surface retainer tabs 34. In FIG. 3B, a notional graphical image 36 has been affixed to the removable display surface 32. In alternative embodiments, the graphical image could be printed directly onto the removable display surface 32 or placed behind a removable display surface 32 made of a transparent material or printed directly onto the display holder.

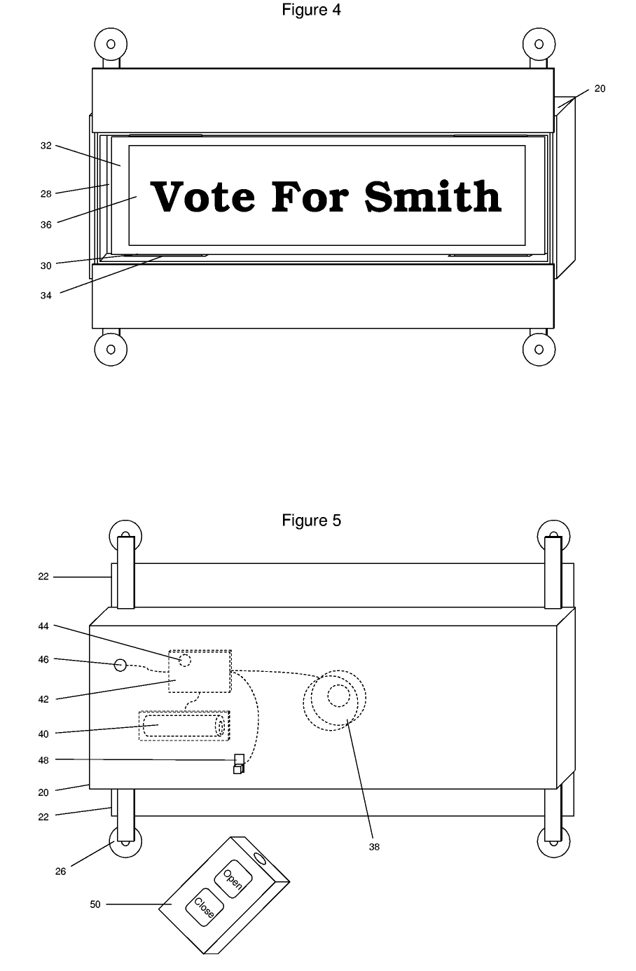

FIG. 4 depicts the device with the obscuring assembly in the unobstructed configuration of FIG. 2. In this figure the removable display surface 32 has been inserted into the display holder 28 and is retained by inserting the surface retainer tabs 34 into the retainer slots 30.

FIG. 5 illustrates the rear of the embodiment of the display device shown in FIG. 4 as well as some internal features. Among these hidden internal features are a motorized actuator 38, a power source 40, a controller 42, and a state sensor 44. Externally visible features of FIG. 5 include a remote control receiver 46 and a switch 48. The motorized actuator 38, the power source 40, the state sensor 44, the remote control receiver 46, and the switch 48 are each in communication with the controller 42, and the controller 42 is energized by the power source 40. The motorized actuator 38 is further in communication with the moveable panels 22. While a motorized actuator is illustrated, alternative actuators such as pneumatic actuators, hydraulic actuators, solenoids, etc. are well known and can be readily conceived. FIG. 5 further illustrates a separate remote control transmitter 50.

When it is desired that the graphical image 36 is obstructed, the user commands the obscuring assembly to assume the obstructed configuration using the remote control transmitter 50. The obscuring assembly may be similarly commanded to assume the unobstructed configuration and reveal the graphical image 36 as desired. This transmitter may be held in the hand, or may be affixed to a stationary portion of a vehicle's interior by a variety of known alternatives such as double sided adhesive tape.

When the remote control transmitter 50 is commanded by a user to change the configuration of the obscuring assembly to an unobstructed configuration, a signal is transmitted by the remote control transmitter 50 to the remote control receiver 46. The signal is encoded such that the controller 42, in communication with the remote control receiver 46 will be signaled to open. Upon receiving the signal to open, the controller 42, in communication with the power source 40, will energize the motorized actuator 38 in the proper direction. The motorized actuator 38, in communication with the movable panels 22, will cause the obscuring assembly formed by the movable panels 22 to open and assume the unobstructed configuration revealing the graphical image 36. The device may be similarly commanded to close the obscuring assembly by a user. In this case the motorized actuator 38 will be operated in the reverse direction, closing the shutter formed by the movable panels 22 and obstructing the view of the graphical image 36. In one embodiment the signal is wireless and is transmitted via infrared light, but many other signal forms are well understood and may be readily conceived.

In addition to the manual method of activation previously described, in the embodiment illustrated in FIG. 5 the display device may also be set to change configurations automatically. This automatic configuration mode is enabled by setting the switch 48 to the proper position. When so positioned, controller 42 interprets the position of the switch 48 and energizes the state sensor 44. In this embodiment the state sensor 44 consists of a motion sensor in communication with a timer. The state sensor 44 is configured such that it will be reset when a predetermined level of motion, such as that caused by driving a vehicle equipped with the display device, is detected. Upon initial activation and each subsequent movement, the state sensor 44 is reset to a predetermined mode which indicates that the obscuring assembly should remain in the unobstructed configuration. After a predetermined amount of time has elapsed without the predetermined level of motion being sensed, the state sensor 44 will trip to a different predetermined mode which indicates that the obscuring assembly should be activated to assume the obstructed configuration. Any change in the mode of state sensor 44 is immediately interpreted by the controller 42, which then energizes the motorized actuator 38 as necessary to achieve the appropriate unobstructed configuration or obstructed configuration of the obscuring assembly. In this way, the graphical image 36 is automatically unobstructed when the vehicle is being driven and automatically obstructed from view a short time after the vehicle is left unattended. While a state sensor comprising a motion sensor in communication with a timer is illustrated in this embodiment, many other state sensors are well known and may be readily conceived. Examples include vibration sensors, inclination sensors, inertia sensors, sensors that are linked to a vehicle's electrical or mechanical systems, etc.

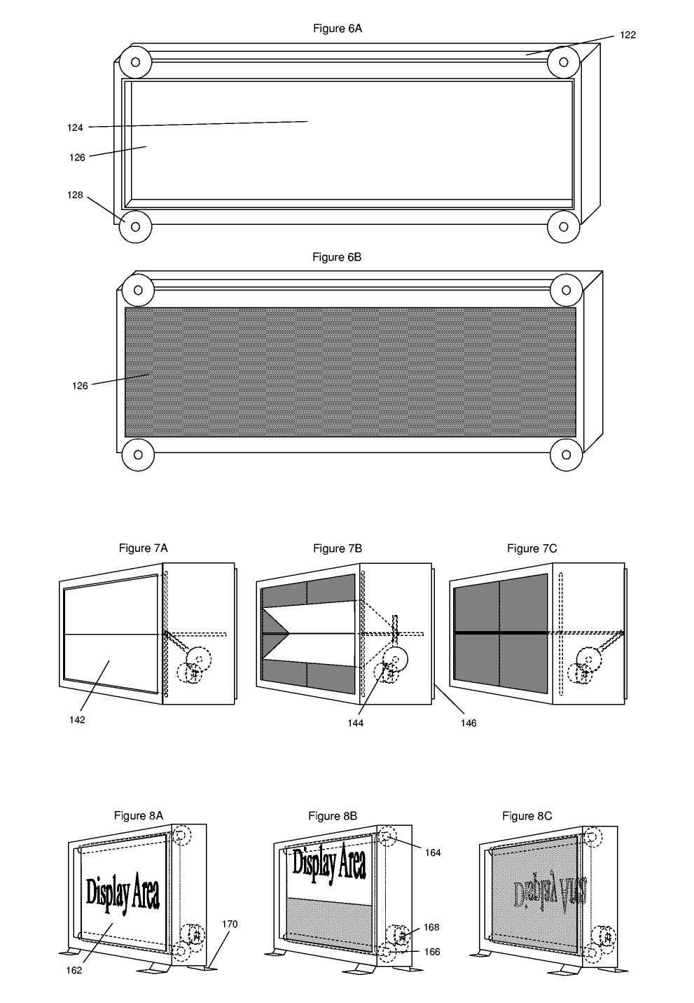

FIGS. 6A and 6B depict an alternative embodiment of the display device. In this embodiment a graphical image is selectively obstructed from view by an obscuring assembly formed by an electro optical cover. The display device is attached to a window by an attachment assembly 128. A graphical image is inserted into a display insertion slot 122 and may be seen in a display holder 126. In FIG. 6A a cover with electronically adjustable transparency 124 is not energized and is transparent. In FIG. 6B the cover with electronically adjustable transparency 124 is energized, causing it to become opaque and assume a configuration wherein the display holder is obstructed from view.

FIGS. 7A, 7B and 7C illustrate another alternative embodiment of the invention. In this embodiment the graphical image is selectively obstructed from view by folding it over upon itself. Further, in this embodiment the display holder is configured to also act as the obscuring assembly. A non-rigid graphical image is affixed to a hinged display holder 142. When activated to assume the obstructed configuration a motor driven actuator 144 operates to fold the display holder 142 upon itself, obstructing the graphical image from view. FIG. 7A shows the invention in an unobstructed configuration with the display holder 142 unfolded and the graphical image area visible. FIG. 7B shows the invention with the obscuring assembly midway between the unobstructed and obstructed configuration. FIG. 7C shows the invention with the obscuring assembly formed by the display area 142 in an obstructed configuration and with the graphical image area obstructed from view. In this embodiment the display device is attached to the exterior of a vehicle by an attachment assembly 146 which is magnetic.

FIGS. 8A, 8B and 8C illustrate yet another alternative embodiment of the display device. In this embodiment the graphical image is selectively obstructed from view by rotating it around an obscuring assembly formed by the display holder and a pair of drums. A display holder 162 made of a flexible material is bonded to itself along one edge. The display holder 162 is secured at its top by an upper drum 164 and at its bottom by a lower drum 166. When activated a drum rotation motor assembly 168 rotates the display holder 162 through one half of a cycle, alternatively obstructing or revealing the graphical image. FIG. 8A shows the display in the unobstructed configuration. FIG. 8B shows the display holder 162 moving while the rotation cycle is in progress. FIG. 8C shows the display holder 162 rotated to the obstructed configuration. In this embodiment the display device is attached to a vehicle by an attachment assembly 170 which consists of a plurality of mounting brackets.

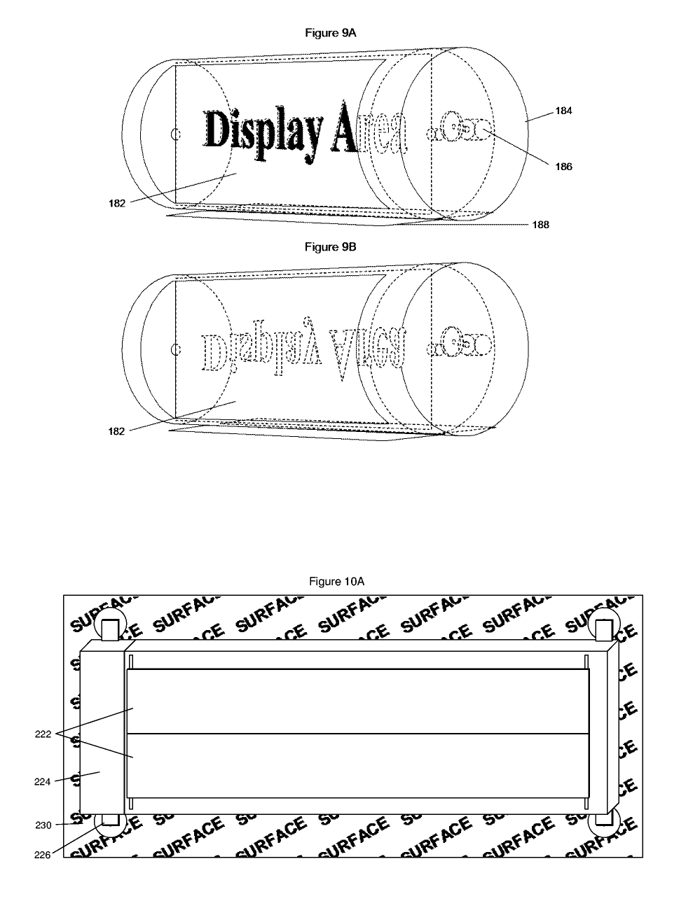

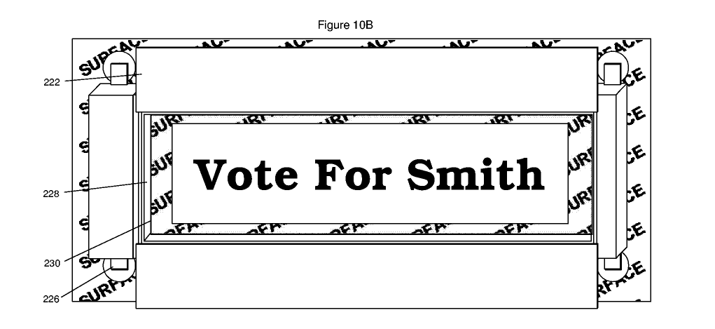

FIGS. 9A and 9B depict still another alternative embodiment of the display device. In this embodiment the graphical image is selectively obstructed from view by an obscuring assembly that flips the display over inside an opaque housing with an open front. A display holder 182 capable if rotating is secured at the center of each end inside a display device 184. A graphical image is affixed to the display holder 182. When activated, a display rotation motor assembly 186 rotates the display holder 182 by 180 degrees along its axis. Each such rotation cycle alternatively obstructs or reveals the graphical image. FIG. 9A shows the obscuring assembly formed by the housing of the display device 184 and the display holder 182 in the unobstructed configuration. In FIG. 9B the obscuring assembly formed by the housing of the display device 184 and the display holder 182 has been rotated to the obstructed configuration. In this embodiment the display device is attached to a vehicle by an attachment assembly 188 which consists of a mounting base secured with double sided adhesive tape.

FIGS. 10A and 10B illustrate yet another embodiment of the invention. In this embodiment the invention is configured to obscure a graphical image that is attached to a separate surface which is not part of the invention. In this embodiment, the display device is affixed to a display mounting surface 230 that is not part of the invention and that is shown for illustration purposes only. The display mounting surface 230 could, for example, represent any visible surface of a vehicle. This embodiment of the invention comprises a frame 224 that is affixed to the display mounting surface 230 by means of an attachment assembly 226. The display device is positioned such that an aperture 228 is located directly over a graphical image separately affixed to the display mounting surface 230. The frame 224 houses the mechanical and electronic elements necessary to operate the device. A pair of moveable panels 222 form an obscuring assembly wherein the shutter formed by the panels may be opened or closed. The obscuring assembly serves to selectively obstruct or reveal the aperture 228 passing through the frame 224. When in the unobstructed configuration, the shutters of the obscuring assembly open to reveal the aperture 228 through which the underlying graphical image may be viewed. When in the obstructed configuration the shutter closes over the aperture 228 preventing the graphical image from being seen. FIG. 10A shows the device in the obstructed configuration with the obscuring assembly closed and the aperture 228 obstructed. FIG. 10B shows the device in the unobstructed configuration, revealing the underlying surface and graphical image which is visible through the aperture 228.

While several embodiments of the invention have been illustrated and described, many changes can be made without departing from the spirit and scope of the invention. For example, the graphical image could be obstructed by a different, uncontroversial graphical image. The graphical image could be automatically obstructed under other given circumstances, such as light or darkness. The graphical image could be partially obstructed to change the message. The obscuring assembly could be a single or multi-piece door. The graphical image could be obstructed through the use of a liquid crystal, polarizing film, or other covering with similar properties. The graphical image could be obstructed by rolling the display holder up around a spindle. The graphical image could be divided into multiple sections with each such section affixed to a rotating panel. The device could be equipped with other features, such as a method of illuminating the graphical image. Accordingly, the scope of the invention is not limited by the disclosure of the illustrated embodiments. Instead, the scope of the invention should be determined entirely by reference to the claims that follow.

What is claimed is:

1. A display device for selectively displaying a graphical image upon a vehicle, the display device including:
a. a display holder adapted to hold the graphical image for display;
b. an attachment assembly coupled to the display holder, the attachment assembly adapted to couple the display holder to a vehicle; and
c. an obscuring assembly configurable between a first configuration in which the graphical image, when held by the display holder, is obstructed from view by the obscuring assembly, and a second configuration in which the graphical image, when held by the display holder, is unobstructed from view by the obscuring assembly for viewing by persons in proximity to the display device.

2. The display device of claim 1 wherein the configuration of the obscuring assembly is determined remotely.

3. The display device of claim 1 wherein the configuration of the obscuring assembly is determined automatically by a state sensor.

4. The display device of claim 3 wherein the state sensor is a timer.

5. The display device of claim 3 wherein the state sensor is a motion sensor.

6. The display device of claim 3 wherein the state sensor is a motion sensor in communication with a timer.

7. The display device of claim 1 wherein the obscuring assembly is a shutter assembly, the shutter assembly having a first position in which the shutter is closed, and a second position in which the shutter is open.

8. The display device of claim 1 wherein the obscuring assembly is a cover with electronically adjustable transparency.

9. The display device of claim 1 wherein the obscuring assembly folds the graphical image such that it is obscured from view.

10. The display device of claim 1 wherein the obscuring assembly rolls the graphical image around a drum such that it is obscured from view.

11. The display device of claim 1 wherein the obscuring assembly moves the graphical image such that it is obscured from view.

12. A display device for selectively displaying a graphical image attached to a vehicle, the display device including:
a. a frame having an aperture passing through the frame;
b. an attachment assembly coupled to the frame, the attachment assembly adapted to couple the frame to a vehicle; and
c. an obscuring assembly configurable between a first configuration in which the aperture is obstructed by the obscuring assembly, and a second configuration in which the aperture is unobstructed by the obscuring assembly such that the graphical image is visible through the aperture for viewing by persons in proximity to the display device.

13. The display device of claim 7 wherein the configuration of the obscuring assembly is determined remotely.

14. The display device of claim 7 wherein the configuration of the obscuring assembly is determined automatically by a state sensor.

15. The display device of claim 9 wherein the state sensor is a timer.

16. The display device of claim 9 wherein the state sensor is a motion sensor.

17. The display device of claim 9 wherein the state sensor is a motion sensor in communication with a timer.

18. A display device for selectively displaying a graphical image through a transparent surface, the display device including:
a. a display holder adapted to hold the graphical image for display;
b. an attachment assembly coupled to the display holder, the attachment assembly adapted to couple the display holder to a transparent surface; and
c. an obscuring assembly configurable between a first configuration in which the graphical image, when held by the display holder, is obstructed from view by the obscuring assembly, and a second configuration in which the graphical image, when held by the display holder, is unobstructed from view by the obscuring assembly for viewing through the transparent surface by persons in proximity to the display device.

19. The display device of claim 18 wherein the configuration of the obscuring assembly is determined remotely.

20. The display device of claim 18 wherein the configuration of the obscuring assembly is determined automatically by a state sensor.
